(19) United States
(12) Patent Application Publication
(10) Pub. No.: US 2012/0180873 A1
(43) Pub. Date: Jul. 19, 2012

(54) METHOD FOR REPLICATING A PRESSURE CONTROL VALVE WITH ADJUSTABLE RESPONSE CHARACTERISTIC

(75) Inventor: William Forrester Seely, Taylors, SC (US)

(73) Assignee: GENERAL ELECTRIC COMPANY, Schenectady, NY (US)

(21) Appl. No.: 13/007,295

(22) Filed: Jan. 14, 2011

(51) Int. Cl. F17D 3/00; G06G 7/64

(52) U.S. Cl. 137/2; 701/100

(57) ABSTRACT

A pressure control valve replication method in a gas turbine can include controlling a fuel flow to a combustion system through a gas control valve, wherein the fuel flow experiences fuel flow changes, adjusting the fuel flow through the gas control valve in response to fuel flow changes in the gas turbine and in response to pressure fluctuations in the gas turbine fuel, replicating a speed ratio valve to control pressure of the fuel flow to the gas control valve.

### BACKGROUND OF THE INVENTION

The subject matter disclosed herein relates to gas turbines and more particularly to systems and methods for providing a method for replicating the behavior of a pressure control valve.

A gas turbine includes valves that control flow and pressure of fuel to combustors in the gas turbine. A speed ratio valve (SRV) controls the pressure of the fuel flow into gas control valves (GCV) prior to the combustor. The SRV and GCVs ultimately control the flow of fuel into the combustors. SRVs are implemented to lower supply pressure at startup as well as to control pressure transients during gas turbine operation so that the flow at the GCVs can be stable, and so that the GCVs can operate in their linear range. Universal valve equations are implemented to design the pressure and flow of the fuel into the valves and combustors. Both valves are considered when calculating the pressure and flow variables. Often variables other than pressure are processed but can be adversely impacted by variations in the pressure. The valves can be modified to be more robust to pressure variations, but at the cost of increasing the total system pressure drop, adversely affecting the fuel flow into the combustor. In general, hardware solutions require additional valves and actuators, or modification to existing valves, increasing hardware costs and pressure drops in the gas turbine system.

### BRIEF DESCRIPTION OF THE INVENTION

According to one aspect of the invention, a pressure control valve replication method in a gas turbine is disclosed. The method can include controlling a fuel flow to a combustion system through a gas control valve, wherein the fuel flow experiences fuel flow changes, adjusting the fuel flow through the gas control valve in response to fuel flow changes in the gas turbine and in response to pressure fluctuations in the gas turbine, replicating a speed ratio valve to control pressure of the fuel flow to the gas control valve.

According to another aspect of the invention, a computer program product for replicating a pressure control valve in a gas turbine is disclosed. The computer program product includes a computer readable medium having instructions for causing a computer to implement a method, which includes controlling a fuel flow to a combustion system through a gas control valve, wherein the fuel flow experiences fuel flow changes, adjusting the fuel flow through the gas control valve in response to fuel flow changes in the gas turbine and in response to pressure fluctuations in the gas turbine, replicating a speed ratio valve to control pressure of the fuel flow to the gas control valve.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a gas turbine fuel supply system in which exemplary embodiments can be implemented.

FIG. 2 illustrates an exemplary gas turbine fuel supply system.

FIG. 3 diagrammatically illustrates steps in producing exemplary algorithms described herein.

FIG. 4 illustrates a diagrammatic example of an exemplary valve pressure compensation equation with a 1^{st} order lag.

FIG. 5 illustrates an exemplary embodiment of a system for providing control valve pressure compensation.

The detailed description explains embodiments of the invention, together with advantages and features, by way of example with reference to the drawings.

### DETAILED DESCRIPTION OF THE INVENTION

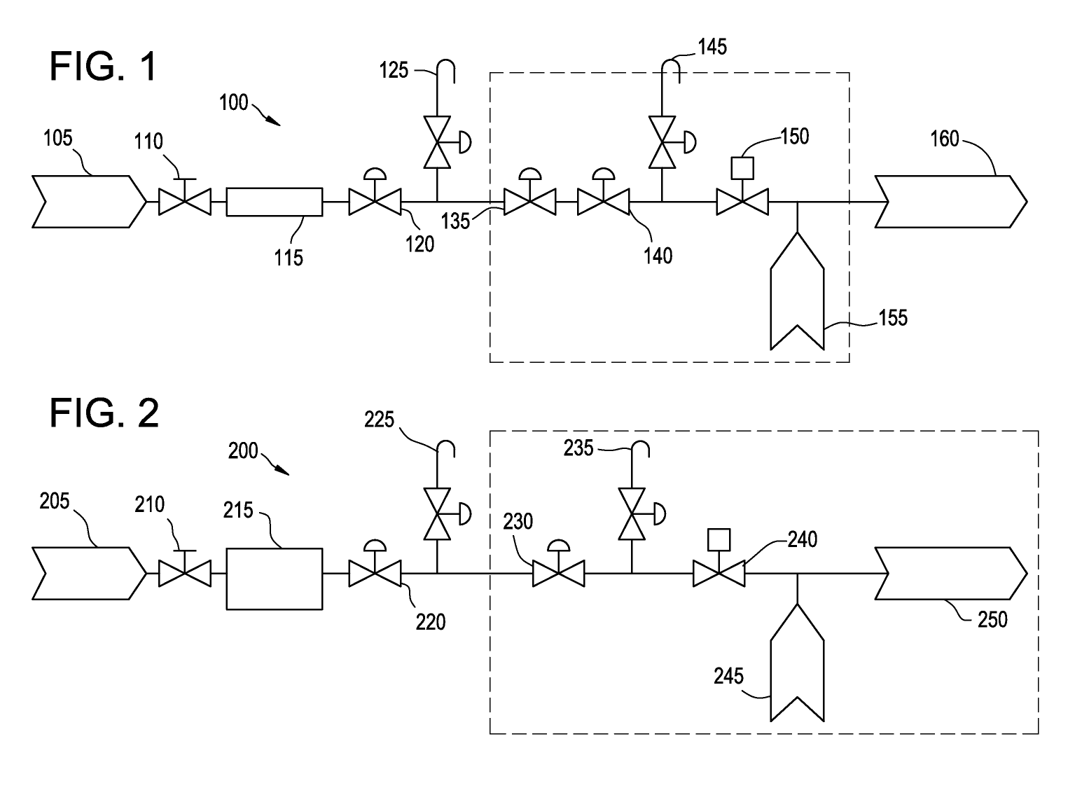

FIG. 1 illustrates a gas turbine fuel supply system 100 in which exemplary embodiments can be implemented. The system 100 can include a gas fuel supply 105, which ultimately supplies fuel to a combustion system 160. A manual isolation valve 110 can be operatively coupled to the gas fuel supply 105 so that the fuel can be manually cut off from the rest of the system 100. A flowmeter 115 determines the amount of fuel flow in the system 100. A safety shutoff valve (SSOV) 120 can be disposed after the flowmeter 115 and be configured to shut down the fuel flow in the event of an occurrence of a predetermined hazardous event in the system 100. The system 100 can further include vent to atmosphere (VTA) valves 125, 145 to blow off excess air pressure in the system 100. For example, the VTA 125 can vent in case of a predetermined hazard condition and the VTA 145 can vent on every shutdown of the system 100. An auxiliary stop valve 135 can further be included in the system 100 to achieve permissible leakage shutoff standards (e.g., a Class VI shutoff). As described herein a speed ratio valve (SRV) 140 controls the speed and thus pressure of the fuel flow into a gas control valve (GCV) 150, which controls the flow to the combustion system 160. An air purge 155 can be implemented evacuate gas from unused manifolds/nozzles in the system 100.

As described herein, the SRV 140 is implemented to lower fuel supply pressure at startup as well as to control pressure transients during gas turbine operation so that the flow at the GCV 150 can be stable and so that the GCV 150 can operate in a linear range. Once the system 100 is running, the SRV 140 can dampen supply pressure. Universal valve equations are implemented to design the pressure and flow of the fuel into the valves and combustors. Both valves are considered when calculating the pressure and flow variables. In exemplary embodiments, the SRV 140 can be removed from the system 100 and the universal valve equation can be modified to control pressure and flow to the GCV 150 alone. The systems and methods described herein therefore implement a pressure compensation/replication algorithm for a valve being controlled to process variables other than pressure such as flow variables. Compensation is determined from a model and provided as a feedforward so that the added compensation's frequency and time-domain response characteristics can be adjusted to fit a desired response. Implementing the pressure compensation algorithm enables removal of the SRV 140 from the system 100, thereby decreasing hardware costs and overall system pressure drops. Modified universal valve equations thereby control flow from the GCV 150, and at the same time adjust the shape of the flow profile to compensate for pressure variations in to the system 100. As such, the strokes of the GCV 150 are adjusted for both choked and unchoked fuel flow to the combustion system 160, thereby adding or subtracting flow to compensate for pressure variations in the system 100. Therefore, the exemplary systems and methods described herein compensate for pressure variations by adjusting the stroke of the GCV 150 depending on the ongoing pressure conditions of the fuel flow.

FIG. 2 illustrates an exemplary gas turbine fuel supply system 200 that can implement modified universal valve equations in accordance with exemplary embodiments. The system 200 can include a gas fuel supply 205, which ultimately supplies fuel to a combustion system 250. A manual isolation valve 210 can be operatively coupled to the gas fuel supply 205 so that the fuel can be manually cut off from the rest of the system 200. A flowmeter 215 determines the amount of fuel flow in the system 200. A SSOV 220 can be disposed after the flowmeter 215 and be configured to shut down the fuel flow in the event of an occurrence of a predetermined hazardous event in the system 200. The system 200 can further include VTA valves 225, 235 to blow off excess air pressure in the system 200. For example, the VTA 225 can vent in case of a predetermined hazard condition and the VTA 235 can vent on every shutdown of the system 200. The system 200 can further include a gas shutoff valve (GSV) 230 that can automatically interrupt the fuel flow in the system 200 in the event that a fault is detected in the system 200. The system 200 can include one or more GCVs 240 to which fuel flow can be controlled by exemplary modified universal valve equations as described herein. An air purge 245 can be implemented to evacuate gas from unused manifolds/nozzles in the system 200.

In exemplary embodiments, changes in the stroke of the GCV 240 are made as pressure is measured in the system. As discussed above, with the SRV (see FIG. 1 SRV 140 for example) removed from the system 200, fuel flow is impacted by disturbances in pressure. As such, the GCV stroke is changed to compensate for pressure disturbances. In exemplary embodiments, choked GCV valves are implemented in order to utilize known valve sizing coefficient tables as described further herein.

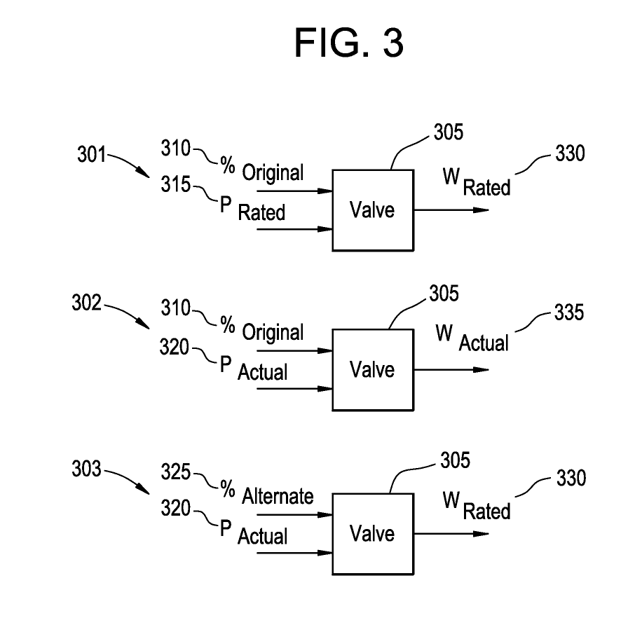

FIG. 3 diagrammatically illustrates steps in producing exemplary algorithms described herein. In a first scenario 301, for some valve strokes in a valve 305 having an original stroke 310, and rated pressure 315, a rated fuel flow 330 is produced. In a second scenario 302, for the same valve stroke in the valve 305 having the original stroke 310 and an alternate actual pressure 320, an alternate actual fuel flow 335 is produced. The original rated fuel flow 330 can be achieved from the alternate actual pressure 320 by using an alternate valve stroke having an alternate stroke 325, as shown in a third scenario 330. It is to be appreciated that the exemplary algorithms described herein eliminate an SRV because the exemplary algorithm can compensate for pressure variations in the fuel supply. In addition, the exemplary algorithms can replicate the lag inherent to the response of an SRV.

In exemplary embodiments, to determine valve stroke (in percentage) as discussed above, the universal valve equation is modified to constantly compensate for pressure changes. The following universal valve equation can be implemented in accordance with exemplary embodiments:

$${w}_{choked} = ( 4.83 \times {10}^{- 4} {C}_{2} \sqrt{\frac{SG}{{T}_{R} Z}} ) {C}_{g} P = {β}_{1} {C}_{g} P \qquad ( 1 )$$

In equation (1), w_{choked} is the choked flow through a valve, C₂ is a specific heat correction factor for the fuel, P is the fuel pressure upstream of the valve (in psi), Cg is a valve sizing coefficient, T_{R} is the temperature of the fuel in Rankin, SG is the specific gravity of the fuel, and Z is the compressibility factor of the fuel. In equation (1), the terms in parentheses do not depend on the pressure and stroke of the valve. A constant term is denoted β₁ to shorten the parenthetical derivations.

For unchoked flow, there is a second term that the choked flow equation must be multiplied by:

$${w}_{unchoked} = sin ( \frac{π}{180} \frac{3417}{{C}_{1} {C}_{2}} \sqrt{\frac{Δ P}{P}} ) {w}_{choked} = {β}_{2} {w}_{choked} \qquad ( 2 )$$

In equation (2), C2, w_{choked}, and P are defined as in equation (1). In addition, C₁ is the ratio of gas and liquid sizing coefficients, ΔP is the pressure drop across the valve. The unchoked flow multiplier is denoted as β₂ to shorten the parenthetical derivations.

For each of the remaining equations described herein, the subscript R refers to the rated or original values for stroke, Cg, pressure, and flow as described with respect to FIG. 3. The subscript A refers to the alternate values for stroke, Cg, pressure, and flow as described with respect to FIG. 3. The alternate stroke is the compensated stroke to give rated flow at the alternate pressure.

For the alternate Cg, the following equations apply:

$$\begin{matrix}{w}_{R} = {β}_{1 R} {β}_{2 R} {P}_{R} {C}_{gR} = {β}_{1 A} {β}_{2 A} {P}_{A} {C}_{gA} & ( 3 ) \\ {C}_{gA} = \frac{{w}_{R}}{{β}_{1 A} {β}_{2 A} {P}_{A}} = \frac{{β}_{1 R} {β}_{2 R} {P}_{R}}{{β}_{1 A} {β}_{2 A} {P}_{A}} {C}_{gR} & ( 4 )\end{matrix}$$

Thus, the alternate Cg is a function of the ratio of pressures and the ratio of universal flow terms

$${C}_{gA} = ( \frac{{P}_{R}}{{P}_{A}} ) ( \frac{{β}_{1 R} {β}_{2 R}}{{β}_{1 A} {β}_{2 A}} ) {C}_{gR} \qquad ( 5 )$$

Cg is a function of valve stroke, which is denoted as:

C_{gR}=cg(%_{R}) (6)

C_{gA}=cg(%_{A}) (7)

In equations (6) and (7), cg is a function that converts percent valve stroke into valve sizing coefficient Cg. The function cg is a property of the valve, and such does not change between the rated and alternate case. This is also the case for β₁, it is also a property of the valve and does not change between the rated and alternate cases, and depends only on fluid properties. Because of these properties, β_{1A}β_{1R}.

The calculation for CgA can then be solved for percent stroke by changing the Cg to it's functional equivalent, and removing the redundant 01 factors:

$${\%}_{A} = {cg}^{- 1} ( ( \frac{{P}_{R}}{{P}_{A}} ) ( \frac{{β}_{2 R}}{{β}_{2 A}} ) cg ( {\%}_{R} ) ) \qquad ( 8 )$$

For choked flow, β_{2A}=β_{2R}=1, and the strokes vary only by the ratio of pressures.

In exemplary embodiments, in order to shape the output response, it is an additive value is produced instead of the multiplicative function as shown in equation (8). The difference in stroke needed to compensate for the difference in pressure from rated pressure can be calculated by putting %_{R} into similar terms as the above equation for %_{A}:

$$\begin{matrix}Δ \% = {\%}_{A} - {\%}_{R} & ( 9 ) \\ {\%}_{R} = {cg}^{- 1} ( ( \frac{{P}_{A}}{{P}_{A}} ) ( \frac{{β}_{2 A}}{{β}_{2 A}} ) cg ( {\%}_{R} ) ) & ( 10 ) \\ Δ \% = {cg}^{- 1} ( ( \frac{{P}_{R} {β}_{2 R} - {P}_{A} {β}_{2 A}}{{P}_{A} {β}_{2 A}} ) cg ( {\%}_{R} ) ) & ( 11 )\end{matrix}$$

Equation (11) is the equation for unchoked flow in accordance with exemplary embodiments. For choked flow, recall that β_{2A}=β_{2R}=1, so the β₂ terms cancel out. As such, substituting back in for β₂ terms, the following equations show the relationship between rated valve stroke and alternate valve stroke. For choked flow:

$$Δ \% = {cg}^{- 1} ( ( \frac{{P}_{R} - {P}_{A}}{{P}_{A}} ) cg ( {\%}_{R} ) ) \qquad ( 12 )$$

For unchoked flow, with ΔP_{X} (where X=A or R) denoting the pressure drop across the valve with P_{X} inlet pressure:

$$Δ \% = {cg}^{- 1} ( ( \frac{\begin{matrix}{P}_{R} sin ( \frac{π}{180} \frac{3417}{{C}_{1} {C}_{2}} \sqrt{\frac{Δ {P}_{R}}{{P}_{R}}} ) - \\ {P}_{A} sin ( \frac{π}{180} \frac{3417}{{C}_{1} {C}_{2}} \sqrt{\frac{Δ {P}_{A}}{{P}_{A}}} )\end{matrix}}{{P}_{A} sin ( \frac{π}{180} \frac{3417}{{C}_{1} {C}_{2}} \sqrt{\frac{Δ {P}_{A}}{{P}_{A}}} )} ) cg ( {\%}_{R} ) ) \qquad ( 13 )$$

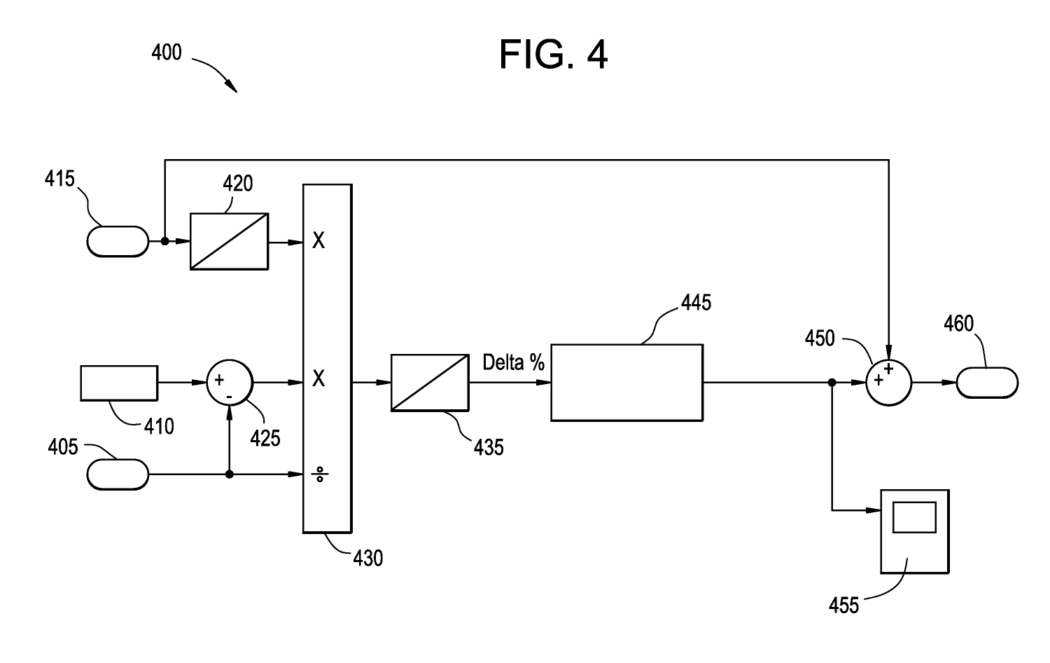

The Δ% value from equation (13) can then be shaped by any means desired (generally a lead or lag compensation/replication). It is to be appreciated that a physical valve can introduce a lag to the fuel flow in the fuel system. As such, with the SRV removed from the system, a natural lag is then removed and the remaining GCV can be overwhelmed with the new fuel flow. In exemplary embodiments, lags can be added to the system through software to compensate for the lag removed with the removal of the SRV. An example implementation of a 1^{st} order lag being used to shape the response of Δ% in the choked version of the equation is illustrated in FIG. 4, which illustrates a diagrammatic example 400 of equation (12), with a 1^{st} order lag added. P_{A} node 405, P_{R} node 410 and %_{R} node 415 are inputs. The difference between P_{R} and P_{A} is calculated at difference node 425 and the valve cg is determined at valve cg table node 420. The valve cg is multiplied with the difference between P_{R} and P_{A} divided by P_{A} at calculation node 430, which is then multiplied with cg at an inverse cg table node 435, which converts cg and produces Δ%, which is the bias added to the rated stroke, %_{R}. The 1^{st} order lag is introduced at filter node 445 and the filtered Δ% is added to the rated stroke, %_{R}, at addition node 450 resulting in the stroke out at node 460. The filtered Δ% can be displayed at display node 455.

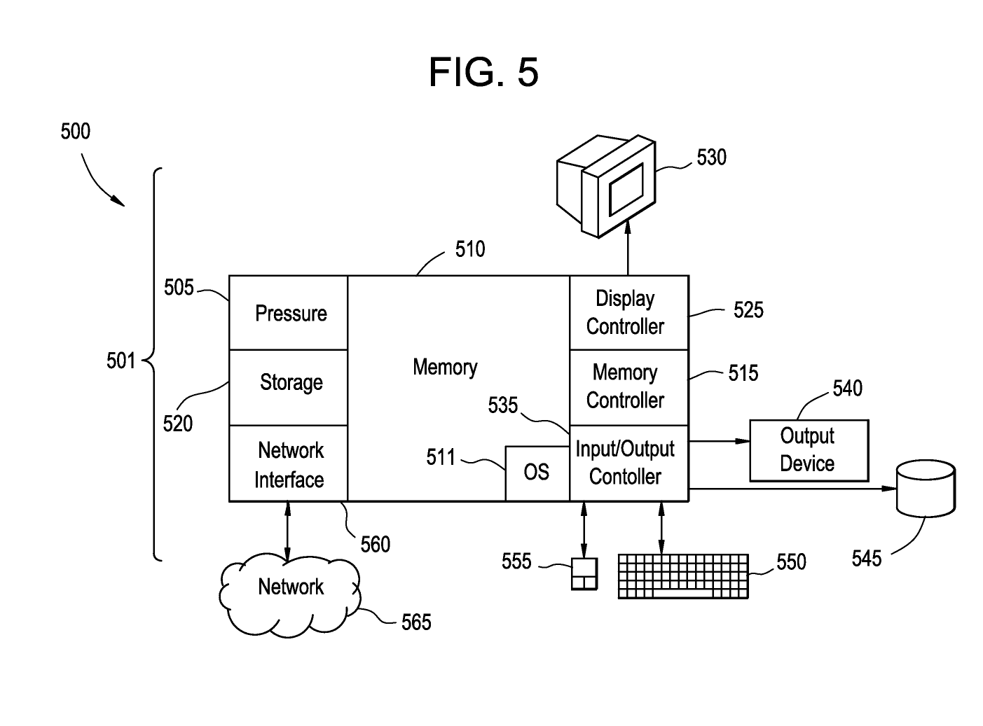

The exemplary algorithms described herein can be implemented in any suitable computing system coupled to the fuel supply system such as shown in FIG. 2. FIG. 5 illustrates an exemplary embodiment of a system 500 for providing control valve pressure compensation. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 500 therefore includes general-purpose computer 501.

In exemplary embodiments, in terms of hardware architecture, as shown in FIG. 5, the computer 501 includes a processor 505, memory 510 coupled to a memory controller 515, and one or more input and/or output (I/O) devices 540, 545 (or peripherals) that are communicatively coupled via a local input/output controller 535. The input/output controller 535 can be, but is not limited to, one or more buses or other wired or wireless connections, as is known in the art. The input/output controller 535 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 505 is a hardware device for executing software, particularly that stored in memory 510. The processor 505 can be any custom made or commercially available processor, a central processing unit (CPU), an auxiliary processor among several processors associated with the computer 501, a semiconductor based microprocessor (in the form of a microchip or chip set), a macroprocessor, or generally any device for executing software instructions.

The memory 510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, and/or other types of storage media. Note that the memory 510 can have a distributed architecture, where various components are situated remote from one another, but can be accessed by the processor 505.

The software in memory 510 may include one or more separate programs, each of which comprises an ordered listing of executable instructions for implementing logical functions. In the example of FIG. 5, the software in the memory 510 includes the control valve pressure compensation methods described herein in accordance with exemplary embodiments and a suitable operating system (OS) 511. The operating system 511 essentially controls the execution of other computer programs, such the control valve pressure compensation systems and methods as described herein, and provides scheduling, input-output control, file and data management, memory management, and communication control and related services.

The control valve pressure compensation methods described herein may be in the form of a source program, executable program (object code), script, or any other entity comprising a set of instructions to be performed. When a source program, then the program needs to be translated via a compiler, assembler, interpreter, or the like, which may or may not be included within the memory 510, so as to operate properly in connection with the OS 511. Furthermore, the control valve pressure compensation methods can be written as an object oriented programming language, which has classes of data and methods, or a procedure programming language, which has routines, subroutines, and/or functions.

In exemplary embodiments, a conventional keyboard 550 and mouse 555 can be coupled to the input/output controller 535. Other output devices such as the I/O devices 540, 545 may include input devices, for example but not limited to a printer, a scanner, microphone, and the like. Finally, the I/O devices 540, 545 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 540, 545 can also include hardware interfaces including but not limited to digital/analog cards, I/O cards and hardware embedded controllers. The system 500 can further include a display controller 525 coupled to a display 530. In exemplary embodiments, the system 500 can further include a network interface 560 for coupling to a network 565. The network 565 can be an IP-based network for communication between the computer 501 and any external server, client and the like via a broadband connection. The network 565 transmits and receives data between the computer 501 and external systems. In exemplary embodiments, network 565 can be a managed IP network administered by a service provider. The network 565 may be implemented in a wireless fashion, e.g., using wireless protocols and technologies, such as WiFi, WiMax, etc. The network 565 can also be a packet-switched network such as a local area network, wide area network, metropolitan area network, Internet network, or other similar type of network environment. The network 565 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 501 is a PC, workstation, intelligent device or the like, the software in the memory 510 may further include a basic input output system (BIOS) (omitted for simplicity). The BIOS is a set of essential software routines that initialize and test hardware at startup, start the OS 511, and support the transfer of data among the hardware devices. The BIOS is stored in ROM so that the BIOS can be executed when the computer 501 is activated.

When the computer 501 is in operation, the processor 505 is configured to execute software stored within the memory 510, to communicate data to and from the memory 510, and to generally control operations of the computer 501 pursuant to the software. The control valve pressure compensation methods described herein and the OS 511, in whole or in part, but typically the latter, are read by the processor 505, perhaps buffered within the processor 505, and then executed.

When the systems and methods described herein are implemented in software, as is shown in FIG. 5, the methods can be stored on any computer readable medium, such as storage 520, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the control valve pressure compensation methods are implemented in hardware, the control valve pressure compensation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include a reduction in valve hardware costs in fuel supply systems. With reduced hardware pressure drops in the fuel supply systems are reduced. Compensation to the fuel flow is made in software and the response characteristics of the compensation can also be made in software. The ability to make changes to the response characteristics reduces valve stroke thus decreases wear on the control valve.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. In a gas turbine, a pressure control valve replication method, comprising:
controlling a fuel flow to a combustion system through a gas control valve, wherein the fuel flow experiences fuel flow changes;
adjusting the fuel flow through the gas control valve in response to the fuel flow changes in the gas turbine; and
in response to pressure fluctuations in the gas turbine fuel, replicating a speed ratio valve to control pressure of the fuel flow to the gas control valve.

2. The method as claimed in claim 1 wherein fuel flow changes in the gas turbine include pressure transients in the fuel flow.

3. The method as claimed in claim 1 wherein replicating the speed ratio valve to control pressure of the fuel flow to the gas control valve comprises adjusting a stroke of the gas control valve from a rated stroke %_{R} to an alternate stroke that produces a rated flow from a non-rated flow.

4. The method as claimed in claim 3 wherein a bias added to the rated stroke to produce the alternate stroke is given by the difference between a measure actual stroke of the gas control valve, %_{A}, and the rated stroke %_{R}, %_{A}−%_{R}.

5. The method as claimed in claim 3 wherein the alternate stroke, %_{R}, of the gas control valve includes at least one of a choked fuel flow and an unchoked fuel flow.

6. The method as claimed in claim 5 wherein the bias added to the rated stroke, Δ%, for a choked fuel flow, is a function of P_{R}, a rated pressure of the gas control valve, and P_{A}, an actual pressure of the gas control valve.

7. The method as claimed in claim 5, wherein the bias added to the rate stroke, Δ%, for an unchoked fuel flow is a function of P_{R}, a rated pressure of the gas control valve, ΔP_{R}, a rated pressure drop, P_{A}, an actual pressure of the gas control valve, and Δ P_{A}, an actual pressure drop.

8. The method as claimed in claim 3 further comprising adding a bias, Δ%, to the rated stroke %_{R}.

9. The method as claimed in claim 8 wherein adding a bias, Δ%, to the rated stroke, %_{R}, utilizes at least one of a lead and lag compensator to replicate the dynamics of a speed ratio valve.

10. The method as claimed in claim 1 wherein replicating the speed ratio valve to control the pressure of the fuel flow to the gas control valve comprises:
adjusting a stroke of the gas control valve from a rated stroke to an alternate stroke; and
adding at least one of lag compensation and a lead compensation to the alternate stroke.

11. A computer program product for replicating a pressure control valve in a gas turbine, the computer program product including a computer readable medium having instructions for causing a computer to implement a method, the method comprising:
controlling a fuel flow to a combustion system through a gas control valve;
adjusting the fuel flow through the gas control valve in response to fuel flow changes in the gas turbine; and
in response to pressure fluctuations in the gas turbine, replicating a speed ratio valve to control pressure of the fuel flow to the gas control valve.

12. The computer program product as claimed in claim 11 wherein fuel flow changes in the gas turbine include pressure transients in the fuel flow.

13. The computer program product as claimed in claim 11 wherein replicating the speed ratio valve to control pressure of the fuel flow to the gas control valve comprises adjusting a stroke of the gas control valve from a rated stroke %_{R} to an alternate that produces a rated flow from a non-rated flow.

14. The computer program product as claimed in claim 13 wherein a bias added to the rate stroke to produce the alternate stroke is given by the difference between a measure actual stroke of the gas control valve, %_{A}, and the rate stroke %_{R}, Δ%=%_{A}−%_{R}.

15. The computer program product as claimed in claim 13 wherein the alternate stroke, %_{R}, of the gas control valve includes at least one of a choked fuel flow and an unchoked fuel flow.

16. The computer program product as claimed in claim 15 wherein the bias added to the rated stroke, Δ%, for a choked fuel flow a function of P_{R}, a rated pressure of the valve, and P_{A}, an actual pressure of the gas control valve, cg is a function that converts the rated stroke of the valve, %_{R}, to a known valve sizing coefficient, and cg⁻¹ is an inverse function of cg.

17. The computer program product as claimed in claim 15, wherein the bias added to the rated stroke, Δ%, for an unchoked fuel flow is a function of P_{R}, a rated pressure of the gas control valve, ΔP_{R}, a rated pressure drop, P_{A}, an actual pressure of the gas control valve, and ΔP_{A}, an actual pressure drop.

18. The computer program product as claimed in claim 13 wherein the method further comprises adding a bias, Δ%, to the alternate stroke %_{A}.

19. The computer program product as claimed in claim 18 wherein adding the bias, Δ%, to the alternate stroke, %_{A}, replicates at least one of a lead and lag of a speed ratio valve.

20. The computer program product as claimed in claim 11 wherein replicating the speed ratio valve to control the pressure of the fuel flow to the gas control valve comprises:
adjusting a stroke of the gas control valve from a rated stroke to an alternate stroke; and
adding at least one of lag compensation and a lead compensation to the alternate stroke.
